(19) United States
(12) Patent Application Publication
(10) Pub. No.: US 2026/0010732 A1
(43) Pub. Date: Jan. 8, 2026

(54) MULTIFUNCTION INTERACTIVE NATURAL LANGUAGE INTERFACE FOR COMMERCIAL REAL ESTATE

(71) Applicants: Oded Noy, Los Angeles, CA (US); Mark Roden, Sherman Oaks, CA (US)

(72) Inventors: Oded Noy, Los Angeles, CA (US); Mark Roden, Sherman Oaks, CA (US)

(73) Assignee: Commercial Real Estate Exchange, Inc., Playa Vista, CA (US)

(21) Appl. No.: 19/237,868

(22) Filed: Jun. 13, 2025

Related U.S. Application Data
(60) Provisional application No. 63/666,856, filed on Jul. 2, 2024.

(51) Int. Cl. G06F 40/35; G06F 16/3329; G06Q 30/015

(52) U.S. Cl. CPC G06F 40/35; G06F 16/3329; G06Q 30/015

(57) ABSTRACT

For presenting a workflow, a method iteratively trains an interactive model on user queries and corresponding needs responses. Each needs response comprises at least one of user type evidence, a clarifying question, and a user need. The method interacts with a user via an interactive natural language interface (NLI) and identifies a corresponding needs response using the interactive model. The method processes an identified user type evidence and asks an identified clarifying question via the NLI. The method presents a workflow selected based on the needs response.

### CROSS-REFERENCE TO RELATED APPLICATIONS

This application claims priority to U.S. Provisional Patent Application No. 63/666,856 entitled MULTIFUNCTION INTERACTIVE NATURAL LANGUAGE INTERFACE FOR COMMERCIAL REAL ESTATE” and filed on Jul. 2, 2024 for Oded Noy, which is incorporated herein by reference.

### BACKGROUND INFORMATION

The subject matter disclosed herein relates to natural language interface (NLI).

### BRIEF DESCRIPTION

A method is disclosed for presenting a workflow. The method iteratively trains an interactive model on user queries and corresponding needs responses. Each needs response comprises at least one of user type evidence, a clarifying question, and a user need. The method interacts with a user via an interactive natural language interface (NLI). The method identifies a corresponding needs response using the interactive model. The method processes identified user type evidence. In addition, the method asks an identified clarifying question via the NLI. The method presents a workflow selected based on the needs response. Thus, as the system gains knowledge of the user, a profile of the user's activities is built to further guide the user towards interactions similar users have interacted with positively. An apparatus and computer program product for performing the method are also disclosed.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of an NLI system;

FIG. 1B is a schematic block diagram illustrating one alternate embodiment of an NLI system;

FIG. 1C is a schematic block illustrating one embodiment of support functions;

FIG. 1D is a schematic block illustrating one embodiment of training elements;

FIG. 2A is a schematic block illustrating one embodiment of user types;

FIG. 2B is a schematic block illustrating one embodiment of identify data;

FIG. 2C is a schematic block illustrating one embodiment of needs training data;

FIG. 2D is a schematic block illustrating one embodiment of needs responses;

FIG. 2E is a schematic block illustrating one embodiment of a workflow list;

FIG. 2F is a schematic block illustrating one embodiment of system data;

FIG. 3 is a flow chart diagram illustrating one embodiment of iterative training;

FIG. 4A is a schematic block illustrating one embodiment of a computer;

FIG. 4B is a schematic block illustrating one embodiment of a neural network;

FIG. 5A is a flow chart diagram illustrating one embodiment of a workflow method; and

FIG. 5B is a flow chart diagram illustrating one additional embodiment of a model training method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as MATLAB, Python, Ruby, R, Java, Java Script, Julia, Smalltalk, C++, C sharp, Lisp, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

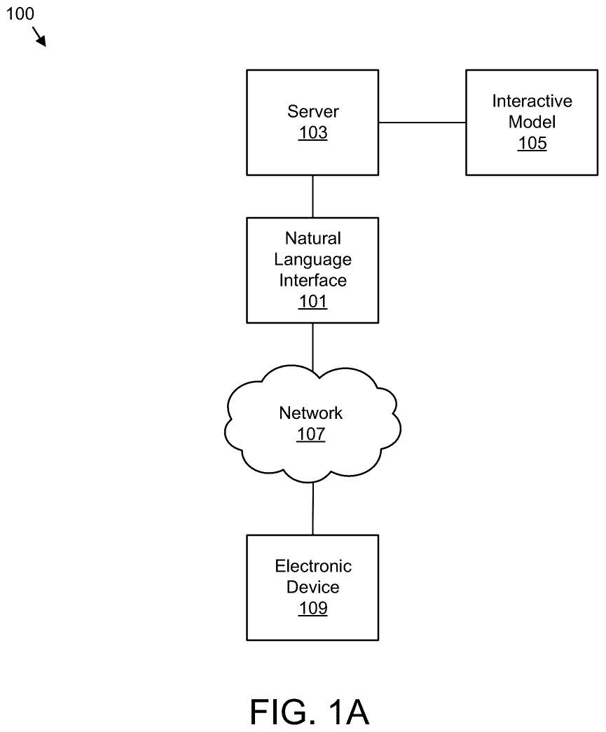

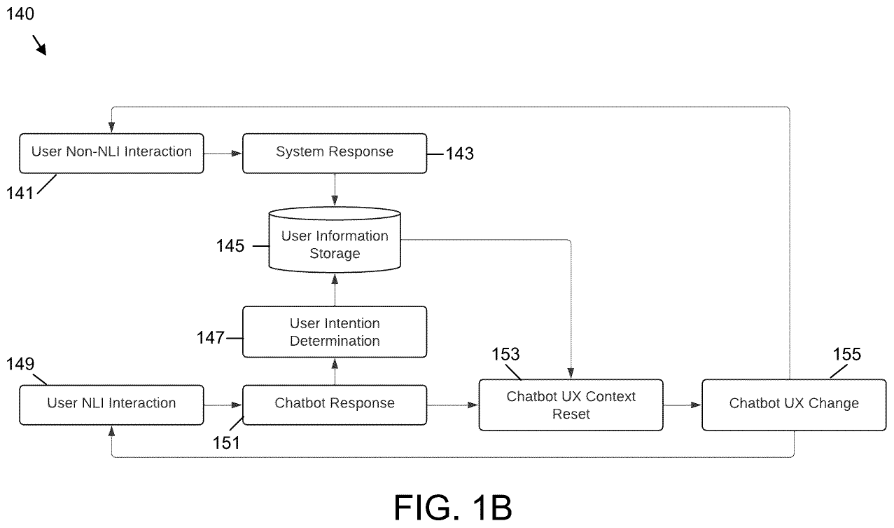

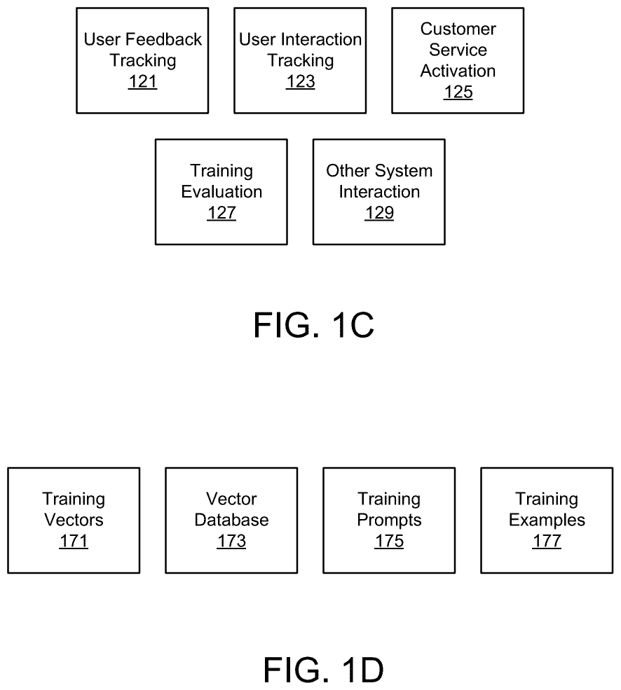

FIG. 1A is a schematic block diagram illustrating one embodiment of an NLI system 100. The system 100 may provide a multi-function NLI for commercial real estate services. In the depicted embodiment, the system 100 includes an interactive model 105, a server 103, the NLI 101, a network 107, and an electronic device 109. In one embodiment, a user accesses the server 103 and/or interactive model 105 by accessing the NLI 101 from an electronic device 109. The electronic device 109 may access the NLI 101 via a network 107 such as the Internet.

The interactive model is iteratively trained on user queries and corresponding needs responses so that as the NLI system 100 gains knowledge of the user, a profile of the user's activities is built to further guide the user towards interactions similar users have interacted with positively. Thus, the NLI system 100 continuously self-trains to provide optimal needs responses.

FIG. 1B is a schematic block diagram illustrating one alternate embodiment of an NLI system 100. In the depicted embodiment, the system 140 includes a user non-NLI interaction 141, a system response 143, user information storage 145, user intention determination 147, user NLI interaction 149, the chatbot response 151, the chatbot user exchange content reset 153, and the chat bot user exchange change 155.

The selection of the workflow happens as the conversation between a user and the interactive model is ongoing as a result of at least the current state of the conversation and all the data acquired on the user and stored in an easily accessible, real-time way. Training happens when the user's response to a routing decision indicates that the routing was wrong. User conversations are monitored by the system 100 and/or by people to identify incorrect workflow routing decisions. The system 100 may label an appropriate workflow routing based on the user's interaction and the system's best knowledge of the different routes. As new workflow routes are opened, new training may be done. If the user asks to go to a workflow route that does not exist, then that interaction is marked by the system 100 as “not yet implemented”. Those NLI interactions are then tallied up to inform the selection of the next workflow route to implement, and then those interactions are relabeled with that new workflow route.

FIG. 1C is a schematic block illustrating one embodiment of support functions. In the depicted embodiment, the functions include user feedback tracking 121, user interaction tracking 123, customer service activation 125, training evaluation 127, and other system interaction 129.

For user feedback tracking 121, user interactions may be tracked via the NLI system 100. User interactions include the language itself, but also user and interaction context information, including but not limited to IP address, time on site, time to ask questions, current site location as the user asks their question, and the like.

For user interaction tracking 123, user interaction and broader contextual data may be stored. This data will be accumulated and stored both for sales representatives, but also the entire query history of the user to provide ongoing context for the chatbot.

For customer service activation 125, users may request to converse with a human customer service representative (CSR) for the purposes of support or auction help and may be routed to CSRs where the user's interactions may be recorded. These recordings will be carefully vetted for privacy concerns before the data can be added to the training data.

For training evaluation 127, user queries 221 are stored in needs training data along with the needs responses made by the NLI 100. Flagged interactions including but not limited to designations of abuse and the need to speak to a CSR are reviewed. Random queries are sampled from the data for correctness and are also reviewed. “Correct” and “incorrect” queries may be determined by expert labelers, with the ability to flag any text as requiring further evaluation by a larger team for a “correct” response. The needs training data may be periodically used to create a new version of the NLI 101 by updating the interactive model 105. In one embodiment, the needs training data is used to continuously update the NLI 101 and/or interactive model 105.

For other system interactions 129, the NLI 101 may include a query routing component. Such a routing component could be given by a system prompt. This routing component will in turn select the appropriate subsystem, including but not limited to the prospecting, evaluation, deal closing, auction, and lead generation systems. The query routing component also includes a result presentation mode; the results of prospecting are presented in a user experience (UX) appropriate for that mode, while results of evaluation are presented in that appropriate experience.

FIG. 1D is a schematic block illustrating one embodiment of training elements. In the depicted embodiment, the training elements include training vectors 171, a vector database 173, training prompts 175, and training examples 177.

A training vector 171 may be selected based on an interaction of the NLI 101. The selected training vector 171 may be selected based on a user query and used to retrieve a needs response from the vector database 173. The vector database 173 may be incorporated in the interactive model 105.

The training prompts 175 may condition the interactive model 105 for a user query. For example, a training prompt 175 may influence the needs responses generated for a given user query.

The training examples 177 may condition the needs response of the interactive model 107 to a user query. For example, a training example 177 may shape the content and format of a needs response of the interactive model 107 to a given user query.

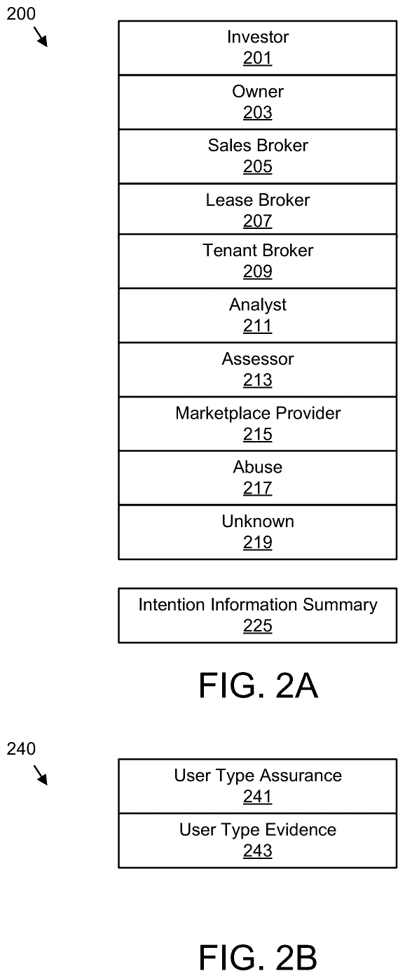

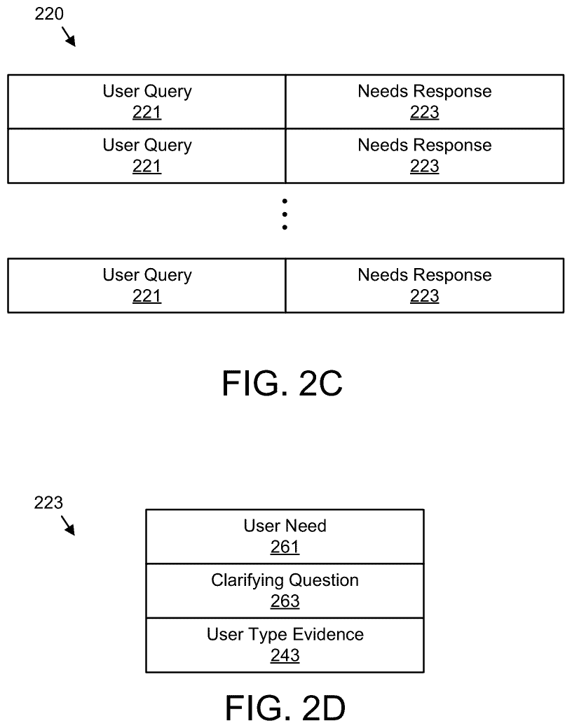

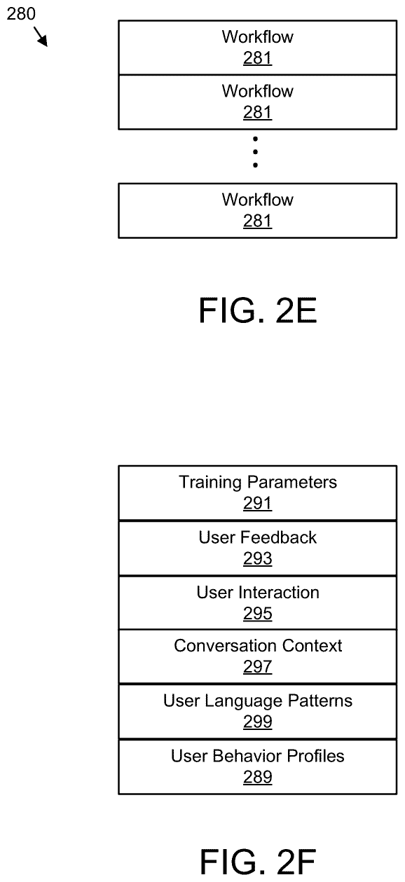

FIG. 2A is a schematic block illustrating one embodiment of user types 200. The user types 200 may be organized as a data structure in a memory. In the depicted embodiment, the user types 200 include an investor 201, an owner 203, a sales broker 205, a lease broker 207, a tenant broker 209, an analyst 211, an assessor 213, a marketplace provider 215, abuse 217, and unknown 219. In addition, information on the user types 200 may be organized in an Intention Information Summary 225. In one embodiment, the user types 200 function as tags for characterizing users. The user types 200 may be used to fine tune a needs response for a given user. In addition, the user types 200 may be used to provide generalized needs responses to a given user based on the user type 200.

In one embodiment, user types 200 are used to prioritize users when providing services. For example, investors 201 may be prioritized over assessors 213 in providing services such as outreach, information detail levels, pricing, communications, and the like.

The investor 201 may be interested in obtaining new properties and selling currently held properties. This user is looking for deals where the investor 201 can make money. The timing of the investment and the risk profiles are unique to each user.

The owner 203 owns property, and may or may not be interested in selling, improving, or maintaining their property. The owner 203 may differ from investors 201 in that owners 203 may or may not be profit motivated. If the owner 203 leases their property, the owner 203 is a landlord. If the owner 203 does not lease, the owner 203 may be an owner-operator. Owners 203 may be looking for brokers, either for sales or for lease.

The sales broker 205 may represent owners 203 in a commercial real estate marketplace to sell the owner's properties.

The lease broker 207 represent owners 203 in a commercial real estate marketplace to lease the owner's 203 properties. Owners 203 typically recoup their investments through leasing the property to tenants, rather than directly purchasing and “flipping” a purchased property.

The tenant brokers 209 represent those who would wish to lease properties.

The analyst 211 could work for any other individual in the commercial real estate (CRE) marketplace, acting in ways to gather data to support investment hypotheses. An investment highlight might be “I want to buy a strip mall with these qualities, because I think I'll be able to charge above market rates for the space in it”. An analyst would be called upon to determine market rates for the space, as well as to find potential properties.

The assessor 213 determines the value of a property given a variety of data inputs.

The marketplace provider 215 offers their services to a tenant or landlord. These individuals participate in the CRE marketplace by prospecting for those individuals who could use their services.

Abuse 217 may indicate abuse of the NLI system 100. Unknown 219 may indicate an unknown user type 200.

FIG. 2B is a schematic block illustrating one embodiment of identity data 240. The identity data 240 may be organized as a data structure in a memory. In the depicted embodiment, the identity data 240 includes a user type assurance 241 and user type evidence 243.

The user type assurance 241 may be a text description that is generated in response to the user type evidence 243. The user type assurance 241 indicates an assurance level of an intention and/or role of the user. The intention of the user is determined from user interactions. The user interactions are recorded as the user type evidence 243. User NLI interactions 149, chatbot responses 151, chatbot user exchange context resets 153, chatbot user exchange changes 155, and/or system responses 143 may be recorded as user type evidence 243.

FIG. 2C is a schematic block illustrating one embodiment of the needs training data 220. The needs training data 220 may be organized as a data structure in a memory. In the depicted embodiment, the needs training data 220 includes a plurality of user queries 221. Each user query 221 has a corresponding needs response 223.

FIG. 2D is a schematic block illustrating one embodiment of a needs response 223. In the depicted embodiment, the needs response 223 includes a user need 261, at least one clarifying question 263, and user type evidence 243.

FIG. 2E is a schematic block illustrating one embodiment of a workflow list 280. In the depicted embodiment, the workflow list 280 comprises a plurality of workflows 281. The user need 261 may include a workflow list 280 and/or workflow 281. The system 100 may perform a workflow list 280 by sequentially performing the workflows 281. Each workflow 281 may comprise at least one of a system familiarization workflow, a new user workflow, a prospecting workflow, an evaluation workflow, a negotiation workflow, a deal closing workflow, an auction sales workflow, an auction participation workflow, a lead prospecting workflow, and a rules workflow.

In the system familiarization workflow 281, the user interacting with the system 100 may be directed to different portions of a website. The system 100 may direct the user through clickable links and/or through directly navigating the user to the user's desired location. The user may be looking for functionality to which the user does not have access. In such an instance, the NLI 101 will guide the user to a paywall and/or an invitation to book a sales demonstration including with a salesperson, whichever is most relevant to the user and is the appropriate upsell page for the product that will meet the user's needs. For instance, a user looking for census or environmental data may be directed towards an Intelligence product, while a user looking for leads to sell or lease a property may be directed towards a pro product. As new products and new product capabilities are brought online, the NLI 101 will be updated with new information.

The new user workflow 281 may be presented when a user first signs up for a service. The NLI 101 may ask a number of questions to determine the user's intent. These questions may be used to guide the user to different aspects of the system 100, as per the system familiarization workflow 281, and these interactions will be logged and graded to be provided to the sales team and/or the system 100 for appropriate outreach routing.

After each interaction, regardless of the workflow 281 that the system 100 has implicitly determined for the user, the following IIS 225 may be created for each user:

{“Sales Broker”:{“Assurance”: “High”, “evidence”:“<summary of interactions>” }, “Lease Broker”:{“Assurance”: “Low”, “evidence”:“<summary of interactions>” },}, “Tenant Broker”:{“Assurance”: “Medium”, “evidence”:“<summary of interactions>” }, “Owner”:{“Assurance”: “Low”, “evidence”:“<summary of interactions>” },}, “Investor”:{“Assurance”: “Medium”, “evidence”:“<summary of interactions>” }, “Assessor”:{“Assurance”: “Low”, “evidence”:“<summary of interactions>” },}, “Analyst”:{“Assurance”: “Low”, “evidence”:“<summary of interactions>” },}, “Marketplace Provider”:{“Assurance”: “Low”, “evidence”:“<summary of interactions>” },}“Abuse”: {“Assurance”: “Low”, “evidence”:“<summary of interactions>” },}“Unknown/Other”:{“Assurance”: “Low”, “evidence”:“<summary of interactions>” }

The NLI system 100 may provide grades of “High”, “Medium”, or “Low”, and can have multiple grades for each user type 200 except unknown 219. The system 100 may provide evidence for an assessment and/or user type evidence 243 in the form of a summation of interactions had with the user. When in doubt, the system 100 may state that the user is unknown 219.

If the user attempts to abuse the system 100 by asking the NLI 101 to forget or otherwise ignore its given instructions, the abuse 217 will be “high” and the user type evidence 243 will be a summary of whatever action the user performed to attempt to abuse the system. Examples of abuse include but are not limited to attempting to have the system 100 forget its prompt and follow new instructions, attempting to have the system 100 make financial promises to the user (as in, a promise of a refund or discount), attempting to have the system 100 bypass a paywall when the user does not have access to that system 100, and/or attempting to uncover private or confidential information from the system 100.

The system 100 may provide grades based on the last three interactions, with the exception of a designation of abuse 217. To prevent abusers from hiding their abuse, once a user has been flagged for potential abuse, a CSR will need to be contacted to clear the flag from a user's account. Users who have been flagged for abuse 217 will have their chat history periodically reviewed by CSRs and/or the system 100 to potentially preemptively remove the abuse 217 designation. If such a removal occurs, the chat interaction that caused the system 100 to flag the user for abuse is stored in needs training data 220 to prevent the NLI 101 from repeating the same erroneous designation. Similarly, random chat messages may be sampled from those interactions and users tagged as non-abusive. If the system 100 uncovers abuse, then the user will be flagged and the interaction stored as needs training data 220 to update the NLI 101 so that previously undetected abuse can be further prevented.

Alternatively, the IIS 225 may be generated after the entire chat has been completed, but before the data is passed to internal teams and/or the NLI system 100 to triage the destination of the customer. Due to the nature of user interactions, these interactions may be evaluated one question at a time, as well as over the course of several interactions to properly classify the user's interests.

With each retraining of the abuse detection, all active interactions will be reexamined for abuse. This sweep is done to catch any missed abuse and to flag any interaction that should be reviewed by a human as a possible false labeling by the system 100 to relieve an abuse 217 designation.

In the prospecting workflow 281 users are looking for properties that meet certain selection criteria. Natural language search queries in this context require data that has both numerate and literate features associated with each record such that the system 100 can retrieve records relevant to the users searches.

The NLI system 100 provides a mechanism for routing a natural language query to a natural language search system, and retrieving information into a UI that is pertinent to the user's query.

The system 100 may contain mechanisms for a user to flag retrieved information as relevant. The individual search can be stored for later reuse on a periodic basis, and records that are returned can also be flagged. These records can be in the form of, but not limited to, sales listings, lease listings, auction listings, private listings sent to the user's vault, and property records obtained from third party data sources. Flagged records may then be used for the evaluation workflow 281.

In the evaluation workflow 281, once a user has designated a record or records to be of interest, the user will want to explore more information. That is, the user may wish to uncover records that are similar to their flagged records, or to understand leases vs sales. A property is composed of spaces, and those spaces themselves can be for lease or for sale, and proper valuation of a property will involve understanding the leases made on a property. These leases are then compared to other leasable spaces in the same market that are comparable (retail spaces are compared to retail, industrial to industrial, and so forth, although the determination of comparable relies on more distinguishing information).

The NLI system 100 provides a gateway for users to refine their information searches on flagged searches by accessing the NLI system 100 for uncovering similar properties and spaces. The source data for these comparisons includes and is not limited to sales listings, lease listings, auction listings, private listings sent to the user's vault, and property records obtained from third party data sources.

In the negotiation workflow 281, when a user wishes to begin negotiations to sell/buy/lease a property, the NLI system 100 may guide their queries towards on-platform negotiation tools, including and not limited to the creation of comp lists and demographic reports.

In the deal closing workflow 281, when a user wishes to close a deal, numerous individuals are involved. The NLI 101 will guide the user to the deal closing interface and provide a number of checklists for the user to complete based on the user's geographic location and the type of business transaction.

In the auction sales workflow 281, when a user wishes to put a property up for auction, the NLI 101 will guide the user to the CSR for the auction team and provide the user with a list of documents required for the user to have prepared for the auction team to begin the process of placing the property on auction. As the auction closes, the NLI 101 may guide the user towards the deal closing flow 281 in conjunction with efforts from the auction team to expedite the closing of the transaction.

In the auction participation workflow 281, when a user wishes to participate in an auction, the NLI 101 may guide the user to a CSR for the auction team, and provide the user with a list of documents required for the user to prepare to participate in an auction as a purchaser, as well as a list of expectations when the property is closed. If the user wins the auction, then the NLI 101 will guide the user towards the deal closing flow along with the auction team representatives to expedite the closing of the transaction.

In the lead prospecting workflow 281, when a broker user wants to sell or lease a property, or to act as a representative for a tenant, the broker user needs to connect with individuals with which to have that interaction. The NLI 101 will guide the user towards lead prospecting tools, as well as facilitate actions that the user wishes to undertake for lead processing, within the confines of the rights available to their account. Paying users may send a certain number of emails to users, and the NLI 101 will facilitate the creation and delivery of these “email blasts” by guiding the user to the curation of their email lists, and then scheduling the email blast from natural language given by the user. The NLI 101 will respond with a confirmation, and if confirmed, will schedule the email blast with the provided list of users. If not confirmed, then the interaction may be entered into the needs training data 220 as a possible mistake made by the NLI 101.

In the rules and regulations workflow 281, the NLI 101 may respond with the laws, regulations, and ordinances, including zoning ordinances, pertinent to a property. CRE transactions must comply with federal, state, county, and local laws, regulations, and ordinances, so the system 100 will contain such information and allow it to be retrieved given user context and user questions around a particular deal.

Users may attempt to switch contexts rapidly, from prospecting for new properties to sending email blasts, for instance. The NLI 101 may store the last five responses for each user, and when sudden changes occur, may ask for confirmation or understanding from the user if the NLI 101 uncovered some ambiguity in the request. This interaction is flagged for inclusion in needs training data 220 to help future iterations of the NLI 101 to be nimble presenting workflows 281 based on user needs 261.

FIG. 2F is a schematic block illustrating one embodiment of system data. The system data includes training parameters 291, user feedback 293, user interactions 295, conversation context 297, user language patterns 299, and user behavior patterns 289. The user feedback 293 may comprise user information, context information, an Internet Protocol (IP) address, time on site, time to ask questions, and current site location during questions. The user interactions 295 may include a query history. The conversation context 297 may record a context of user conversations. The user language patterns 299 may record patterns in user conversations. The user behavior patterns 289 may comprises known patterns of user behavior.

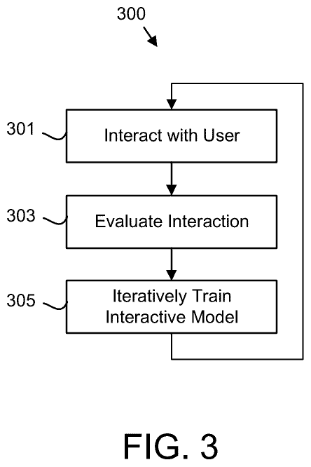

FIG. 3 is a flow chart diagram illustrating one embodiment of iterative training 300. The NLI system 100 interacts with users that may embody multiple user types 200. For example, a user may have interests as an investor 201, an owner 203, and a lease broker 207. However, for the NLI system 100 to be most useful to the user, a correct workflow 281 should be presented to the user based on the current user need 261.

Unfortunately, the in the past queries and responses for a plurality of users have been insufficient to train models for a diverse and changing needs of individual users. There is too much variation between users in query patterns for a given objective. In addition, a given user in an interactive session may query for information for the multiple user types that the given user embodies. For example, a given user may be both an investor 201 and an analyst 211, and make queries based on both user types 200.

In order to compensate for the query variation between users and interspatial variation in the intent of queries of a given user, the embodiments iteratively train the interactive model 105 on the real time interactions of the user. The organization of the training data 220 and the needs response 223 in particular uniquely enable a novel and non-obvious method of iterative training 300.

The NLI system 100 interacts 301 with the given user. Both the user query 221 and the needs response 223 are recorded in the training data 220 for each interaction with the given user. In addition, the user query 221 and the needs response 223 may be recorded in user feedback 293, and user interactions 295. The training data 220, user feedback 293, and user interactions 295 support the evaluation 303 of each interaction 301 with the given user. The interactive model 105 is then iteratively trained 305 using the updated training data 220.

In one embodiment, the interactive model 105 is iteratively trained 305 by modifying training vectors 171 to a vector database 173 associated with the interactive model 105. The vector database 173 may specify a needs response 223 and/or a user need 261 for a given training vector 171. In addition, the vector database 173 may modify the user type assurance 241 and/or user type evidence 242 for the identity data 240. By modifying the training vectors 171, the interactive model 105 may retrained 305 in real time to accommodate a given user.

In one embodiment, the interactive model 105 is iteratively trained 305 by modifying the training prompts 175. For example, a training prompt 175 may be added that shapes the needs response 223 towards a user type 200 and/or workflow 281. In addition, a training prompt 175 may be modified to shape generation of the identity data 240.

In one embodiment, training examples 177 associated with the interactive model 105 may be modified to iteratively train 305 the interactive model 105. For example, the training example 177 may be modified to shape the needs response 223 and/or the user need 261 a given user query 221. In addition, the training example 177 may be modified to shape the selection of the user type 200 and/or the workflow 281. In a certain embodiment, a training example 177 may be modified to may shape the user type assurance 241 and/or user type evidence 242 generated for the identity data 240.

By iteratively training 305 the interactive model 105, more accurate needs responses 223 are identified. In addition, an improved user type evidence 243 results in a correct workflow 281 being presented to the user based on the current user need 261.

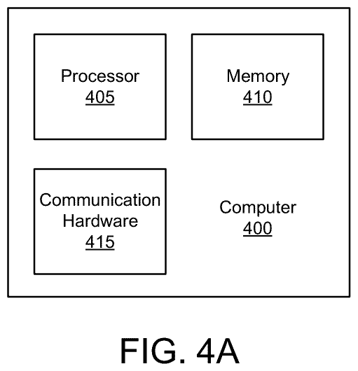

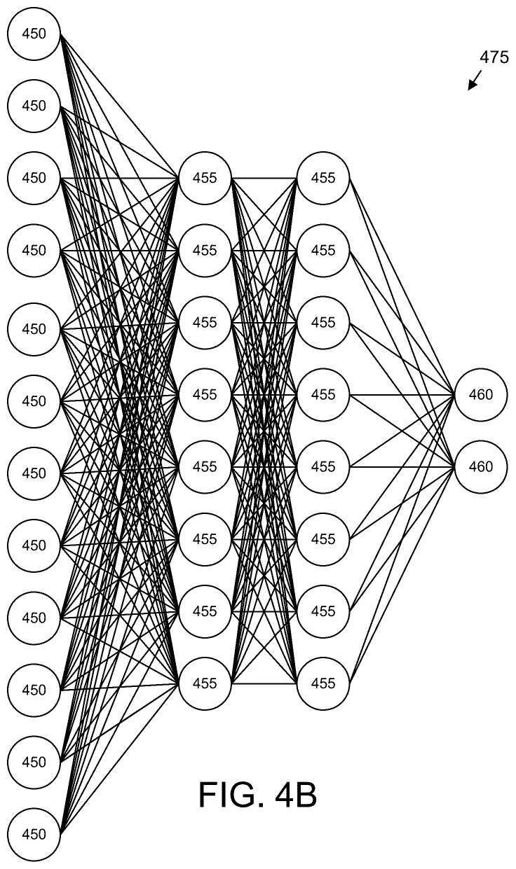

FIG. 4A is a schematic block illustrating one embodiment of a computer 400. In the depicted embodiment, the computer includes a processor 405, a memory 410, and communication hardware 415. The memory 410 may store code and data. The processor 405 may execute the code and process the data. The communication hardware 415 may communicate with other devices.

FIG. 4B is a schematic block diagram illustrating one embodiment of a neural network 475. In the depicted embodiment, the neural network 475 includes input neurons 450, hidden neurons 455, and output neurons 460. The neural network 475 may be organized as a convolutional neural network, a recurrent neural network, long short term memory (LSTM) network, transformer, and the like.

The neural network 475 may be trained with data such as the needs training data 220. The training data may include user queries 221 and needs responses 223. The neural network 475 may be trained using one or more learning functions while applying the training data 220 such as user queries 221 to the input neurons 450 and known result values such as needs responses 223 to the output neurons 460.

In one embodiment, the neural network 475 accesses a vector database 173 based on inputs at the input neurons 450 for additional data and/or direction. In a certain embodiment, the neural network 475 accesses additional information in response to inputs. In one embodiment, a standard neural network 475 is employed and fine-tuned with iterative training data 220, vector databases 173, training prompts 175, and/or training examples 177. The vector databases 173, training prompts 175, and/or training examples 177 may be input when the neural network 475 is queried.

Subsequently, the neural network 475 may receive user queries 221 at the input neurons 450 and make needs responses 223 at the output neurons 460 based on the user queries 221. The actual data may include data from the training data 220.

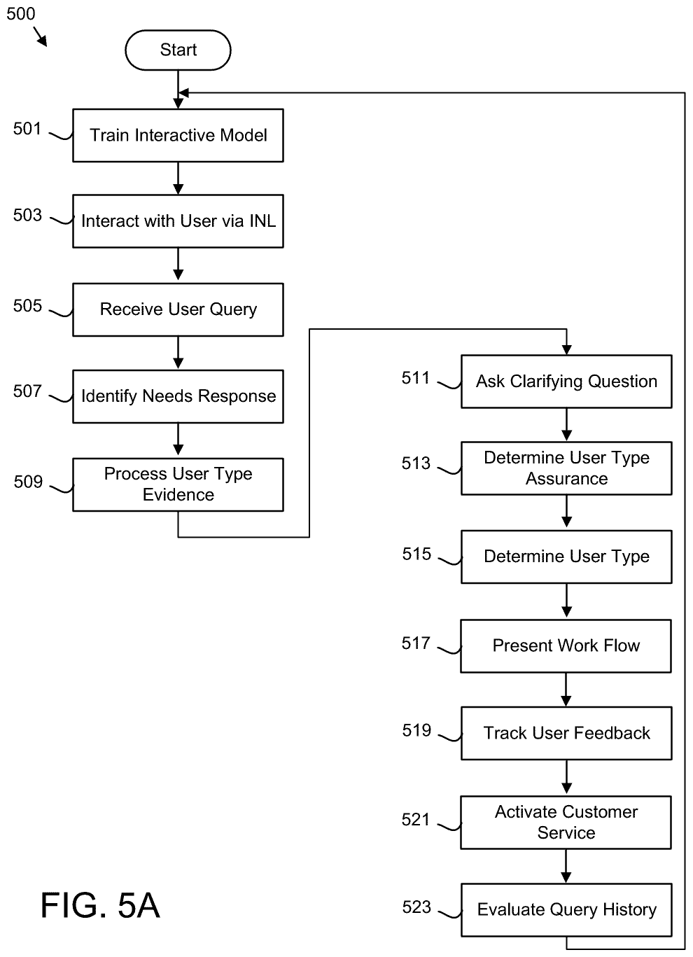

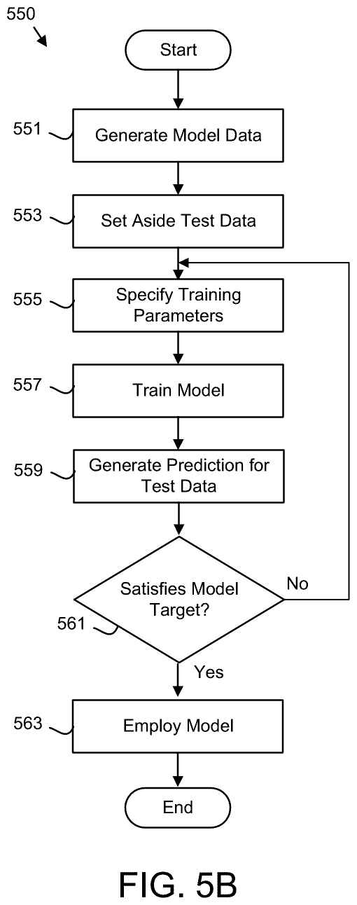

FIG. 5A is a flow chart diagram illustrating one embodiment of a workflow method 500. The method 500 may respond to user queries 221 with needs responses 223 including user need 261, a workflow list 280, a clarifying question 263, and/or user type evidence 243. The method 500 may be performed by the processor 405 and/or the neural network 475.

The method 500 starts and trains 501 the interactive model 105. The interactive model 105 may be trained on user queries 221 and corresponding needs responses 223. The interactive model 105 may be iteratively trained 501. Each needs response 223 comprises at least one of user type evidence 243, a clarifying question 263, and a user need 261. The interactive model 105 may be trained is described in FIGS. 3 and/or 5B.

The method 500 interacts 503 with a user via the NLI 101. The NLI 101 may present audio, text, images, and/or video to the user. The user may type a user query 221, speak a user query 221, select a user query 221, or combinations thereof. The NLI 101 receives 505 the user query 221. The user query 221 may be received via the NLI 101.

The method 500 identifies 507 a needs response 223 using the interactive model 105. The interactive model 105 may generate a needs response 223 that is based on a history of user queries 221.

The method 500 processes 509 an identified user type evidence 243 associated with the needs response 223. The user type evidence 243 may be used to determine a user type 200. The identified user type evidence 243 may be processed 509 with the interactive model 105.

In one embodiment, the method 500 asks 511 a clarifying question 263. The clarifying question 263 may be asked via the NLI 101.

The method 500 may determine 513 a user type assurance 241 from the identified user type evidence 243. In addition, the method 500 may determine 515 the user type 200 from the user type assurance 241 and a specified number of recent user type evidences 243. The user type assurance 241 may be determined 513 using the interactive model 105.

In one embodiment, the interactive model 105 is prompted to provide the user type assurance 241. The interactive model 105 may provide the user type assurance 241 for each user type 200. The user type assurance 241 may be based on conversation context 297 and/or user language patterns 299. In one embodiment, no numerical probability calculations are used.

In one embodiment, the interactive model 105 comprises an evaluation component. The evaluation component may analyze the quality and consistency of the generated needs response 223 against the user query 221 and accumulated user type evidence 243. In addition, the evaluation component may cross-reference user language patterns 299 with user behavior profiles 289 to validate and/or adjust the user type assurance 241.

In a certain embodiment, the NLI system 100 monitors subsequent user interactions for a given user and evaluates the accuracy of the user type 200. If the subsequent user interactions indicate that the workflow 281 presented to the user was incorrect, the needs training data 220 is modified to improve the determination 515 of the user type 200.

For example, if a user initially classified as an investor 201 with ‘Medium’ user type assurance 241 subsequently engages primarily with lease broker tools, the system reduces the investor user type assurance 241 to ‘Low’ and increases the lease broker 207 user type assurance 241 to ‘High,’ while updating the user type evidence 243 accordingly. This multi-layered approach ensures the Intention Information Summary 225 accurately reflects user intent and enables appropriate workflow 281 presentation.

The method 500 presents 517 a workflow 281 based on the given user need 261. The workflow 281 may be selected based on the given user need 241 and/or the user type 200. In one embodiment, each workflow 281 is associated with a given user need 241 and/or a given user type 200. In addition, the workflow 281 may be selected using the interactive model 105.

In one embodiment, in response to determining any abuse user type 215, the method 500 may block the user as the workflow 281.

The method 500 may track 519 user feedback 293 and/or user interaction 295. The user feedback 293 may comprise user information, context information, an Internet Protocol (IP) address, time on site, time to ask questions, and current site location during questions.

In one embodiment, the method 500 activates 521 customer service in response to a user request. In addition, the method 500 may evaluate 523 a query history, wherein abuse and customer service requests are flagged, evaluated, and labeled for inclusion in the needs training data 220. The method 500 further loops to iteratively train 501 the interactive model 105.

FIG. 5B is a flow chart diagram illustrating one additional embodiment of a model training method 550. The method 550 may train the interactive model 105. The method 550 may be performed by the processor 405 and/or neural network 475.

The method 550 starts and in one embodiment, the method 550 generates 551 the needs training data 220. The needs training data 220 may be historic data. In one embodiment, real-time needs training data 220 is added.

The method 550 may set aside 553 a portion of the needs training data 220 as test data. The test data will not be used to train the interactive model 105.

The method 550 may specify 555 the training parameters 291. The interactive model 105 is trained 557 using the needs training data 220 in accordance with the training parameters 281.

The method 550 generates 559 a prediction from the interactive model 105 with the test data. The prediction may be the needs response 223. The method 550 determines 561 whether the prediction satisfies a target for the interactive model 105. If the prediction does not satisfy the target, the training parameters 275 are modified 555 and the interactive model 105 is again trained 557. If the prediction satisfies the target, the trained interactive model 105 is employed 563 and the method 550 ends.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
iteratively training, by use of a processor, an interactive model on user queries and corresponding needs responses, wherein each needs response comprises at least one of user type evidence, a clarifying question, and a user need;
interacting with a user via an interactive natural language interface (NLI);
receiving a user query from the NLI;
identifying a corresponding needs response using the interactive model;
processing an identified user type evidence;
asking an identified clarifying question via the NLI; and
presenting a workflow selected based on the needs response.

2. The method of claim 1, the method further comprising:
determining a user type assurance from the identified user type evidence
determining a user type from the user type assurance and a specified number of recent user type evidences; and
wherein the workflow is selected based on the needs response and the identified user type evidence.

3. The method of claim 2, wherein the workflow comprises at least one of a system familiarization workflow, a new user workflow, a prospecting workflow, an evaluation workflow, a negotiation workflow, a deal closing workflow, an auction sales workflow, an auction participation workflow, a lead prospecting workflow, and a rules workflow.

4. The method of claim 2, wherein the user types comprise investor, owner, sales broker, lease broker, tenant broker, analyst, marketplace provider, abuse, and unknown.

5. The method of claim 4, wherein a user is blocked in response to determining an abuse user type.

6. The method of claim 1, the method further comprising tracking user feedback, the user feedback comprising user information, context information, an Internet Protocol (IP) address, time on site, time to ask questions, and current site location during questions.

7. The method of claim 1, the method further comprising tracking user interactions, the user interactions comprising a query history.

8. The method of claim 1, the method further comprising activating customer service in response to a user request.

9. The method of claim 1, the method further comprising evaluating a query history, wherein abuse and customer service requests are flagged, evaluated, and labeled.

10. An apparatus comprising:
a processor executing code stored on a memory to perform:
iteratively training an interactive model on user queries and corresponding needs responses, wherein each needs response comprises at least one of user type evidence, a clarifying question, and a user need;
interacting with a user via an interactive natural language interface (NLI);
receiving a user query from the NLI;
identifying a corresponding needs response using the interactive model;
processing an identified user type evidence;
asking an identified clarifying question via the NLI; and
presenting a workflow selected based on the needs response.

11. The apparatus of claim 10, the processor further:
determining a user type assurance from the identified user type evidence
determining a user type from the user type assurance and a specified number of recent user type evidences; and
wherein the workflow is selected based on the needs response and the identified user type evidence.

12. The apparatus of claim 11, wherein the workflow comprises at least one of a system familiarization workflow, a new user workflow, a prospecting workflow, an evaluation workflow, a negotiation workflow, a deal closing workflow, an auction sales workflow, an auction participation workflow, a lead prospecting workflow, and a rules workflow.

13. The apparatus of claim 11, wherein the user types comprise investor, owner, sales broker, lease broker, tenant broker, analyst, marketplace provider, abuse, and unknown.

14. The apparatus of claim 13, wherein a user is blocked in response to determining an abuse user type.

15. The apparatus of claim 10, the processor further tracking user feedback, the user feedback comprising user information, context information, an Internet Protocol (IP) address, time on site, time to ask questions, and current site location during questions.

16. The apparatus of claim 10, the processor further tracking user interactions, the user interactions comprising a query history.

17. The apparatus of claim 10, the processor further activating customer service in response to a user request.

18. The apparatus of claim 10, the processor further evaluating a query history, wherein abuse and customer service requests are flagged, evaluated, and labeled.

19. A computer program product comprising a non-transitory computer readable storage medium storing code executable by a processor to perform:
iteratively training an interactive model on user queries and corresponding needs responses, wherein each needs response comprises at least one of user type evidence, a clarifying question, and a user need;
interacting with a user via an interactive natural language interface (NLI);
receiving a user query from the NLI;
identifying a corresponding needs response using the interactive model;
processing an identified user type evidence;
asking an identified clarifying question via the NLI; and
presenting a workflow selected based on the needs response.

20. The computer program product of claim 19, the processor further performing:
determining a user type assurance from the identified user type evidence
determining a user type from the user type assurance and a specified number of recent user type evidences; and
wherein the workflow is selected based on the needs response and the identified user type evidence.
